(19) United States
(12) Patent Application Publication
(10) Pub. No.: US 2021/0022226 A1
(43) Pub. Date: Jan. 21, 2021

(54) A METHOD AND SYSTEM TO DETECT AND QUANTIFY DAYLIGHT THAT EMPLOYS NON-PHOTO SENSORS

(71) Applicant: PHILIPS LIGHTING HOLDING B.V., Eindhoven (NL)

(72) Inventors: MATHAN KUMAR GOPAL SAMY, MEDFORD, MA (US); MAULIN DAHYABHAI PATEL, TUCKAHOE, NY (US)

(21) Appl. No.: 16/074,172

(22) PCT Filed: Jan. 30, 2017
(86) PCT No.: PCT/EP2017/051924

§ 371 Date: Jul. 31, 2018

Related U.S. Application Data
(60) Provisional application No. 62/291,647, filed on Feb. 5, 2016.

(30) Foreign Application Priority Data
Apr. 19, 2016 (EP) 16165981.8

(51) Int. Cl. H05B 47/11; G01J 5/12; G01J 5/28; H05B 47/115; E06B 9/32

(52) U.S. Cl. CPC H05B 47/11; G01J 5/12; G01J 5/28; G01J 2005/283; E06B 9/32; G01J 2005/123; H05B 47/115

(57) ABSTRACT

A method and corresponding system is disclosed in which the overall illuminance of an environment is analyzed to in order to detect and quantify the daylight component of the illuminance. The invention utilizes a combination of visual and non-visual sensors and a signal processing algorithm that filters and analyzes the sensor data.

This application relates to the field of light management systems and more particularly to a method and a system for controlling light distribution in a space including one or more installed light sources and an external light source.

With the increased emphasis on energy conservation, systems for controlling electrical energy consumed by lighting systems are being used. Such systems typically include utilization of available daylight. In fact, in many countries it is required by regulation to implement daylighting in buildings (both new and retrofit construction). An example of such a system is described in co-pending application no. WO2013140292 entitled “A METHOD FOR CONTROLLING BLIND SLAT ANGLE AND HEIGHT OF A SINGLE MOTOR BLIND”; the entire contents of which are hereby incorporated by reference. However, in such systems there are challenges in reliably detecting daylight and responding in real-time when using low cost sensors.

That is, the performance of daylight harvesting lighting control system is tightly linked to the performance of the photo-sensor that senses the ambient light. Low cost photo-sensors in general are inaccurate and deteriorate over the lifetime of the device. Because such sensors measure light (direct/reflected, artificial/natural) accumulated at the photodiode, they cannot distinguish between light from artificial (e.g., luminaires) and natural sources (e.g., sunlight). In particular, since the spectrums of daylight and artificial light are different, the photo-sensor responds differently to daylight compared to the artificial light (e.g., such sensors are more sensitive to daylight than artificial light).

Existing daylight harvesting lighting control systems typically dim the artificial light in proportion to the overall illuminance. Since the photo-sensors are more sensitive to daylight than artificial light, this results in over-dimming of artificial light. If the sensors can distinguish between daylight and artificial light, then the control system can respond to them differently to address this over-dimming issue.

Further, it has been observed that the prior art closed-loop independent blind and lighting control strategy results in poor performance in terms of attaining savings in lighting energy consumption. The main reason is the slower response time of a typical blind control system compared to a typical lighting control system. Consider a scenario where the blind slats are partially open and daylight is sufficient to meet the target set point. Accordingly, the electric lights are off. Now, suddenly clouds appear in the sky, so the internal illuminance drops below the target set point. The closed-loop blind control system will react to this change by opening the blinds in say 5 degree increments. At the same time, the closed-loop lighting control system will also notice this change and brighten the electrical light to reach the set point. Since the response time of electric lights is faster than blinds, it can bridge the gap quickly while the blind system is slowly opening the slats. After the set point has been reached due to the brightening of electric lights, the blinds stop opening further. Thus a steady state is reached where blinds are partially open and electric lights are illuminating at a level that is not optimal for saving energy. This issue can be mitigated if the sensor can distinguish between daylight and artificial light. This will enable the system to realize that the blinds need to open further because there is some room to harvest more daylight—even though the set point may have been reached due to mixed (daylight+artificial) light.

In addition, modern lighting systems can actively control window/façade blinds to save HVAC cooling energy by avoiding heat gain from daylight. Currently, this is performed by attributing an increase in indoor light level (i.e., and increase over the level originally designed using electrical light) to daylight, and thereby computing heat gain entering the space. Such methods could be inaccurate because the photo-sensors cannot distinguish between electrical and daylight. It is known that HVAC is the most energy consuming subsystem in a typical building and HVAC devices have longer hysteresis (sometimes hours). Accordingly, any simple error or inaccuracy in photo level based blind control could have significant energy implications in a building.

Still further, many current systems employ data loggers for estimating energy savings potential for occupancy sensing and daylight harvesting lighting control systems. These loggers log the occupancy and illuminance data to find out when the space was unoccupied and lights were left on. Whether lights are turned on or off is estimated based on sudden changes in illuminance. Because the photo-sensor in such current data logger systems cannot distinguish between daylight and artificial light, a sudden change in daylight (e.g., someone closing or opening the blinds, or a cloud passing by) can be improperly interpreted as artificial lights being switched on or off. This issue can be overcome if the system's sensor(s) can distinguish between daylight and artificial lights.

In the current invention described herein, a system is provided in which daylight is detected and quantified using a combination of visual and non-visual sensors.

In the following detailed description, for purposes of explanation and not limitation, representative embodiments disclosing specific details are set forth in order to provide a thorough understanding of the claimed invention. However, it will be apparent to one having ordinary skill in the art having had the benefit of the present disclosure that other embodiments according to the present teachings that depart from the specific details disclosed herein remain within the scope of the appended claims. Moreover, descriptions of well-known apparatus and methods may be omitted so as to not obscure the description of the representative embodiments. Such methods and apparatus are clearly within the scope of the claimed invention. For example, aspects of the methods and apparatus disclosed herein are described in conjunction with being mounted on the ceiling or a wall of a room. However, one or more aspects of the methods and apparatus described herein may be implemented in other configurations such as, for example, various recessed products such as lighting fixtures, cameras, speakers, and/or ventilation systems that may be installed in a recessed configuration.

In various embodiments of the invention, an indoor region (a “lighting zone”) is monitored with a thermopile array and at least one photo-sensor. The raw sensor outputs of these devices are filtered, processed and operated on by algorithms in real-time. A process will then perform on-sight estimation of the zone's exposure to daylight (e.g., “yes/no”), level of daylight (e.g., “high/medium/low”), and estimated daylight intensity (e.g., “700 lux”).

In further embodiments of the invention, calibration of the sensors is performed after the system is installed. In an exemplary calibration process, measurements of light level and thermopile array readings at different dimming levels with (say, at mid-day) and without (say, at night) presence of daylight. A simple regression model is then developed from these data points that can estimate:
a) Whether daylight is present or not given the data from photo-sensor and thermopile array. A simple threshold-based approach can be followed.
b) Qualitative measure of daylight if present. A simple binary decision tree (BDT) classifier shall be developed using the data collected in the step above. When daylight is present, the BDT classifier shall generate one of the labels (high, medium, low), based on recent real-time data, to qualitatively measure the daylight. Some of the cut values or supervised labels required can be developed apriori.

In still further embodiments, a more sophisticated regression model can be developed (either on-site or off-site) to estimate the amount of daylight (in lux) present in the zone of measurement. This model again exploits light dimming level, photo-sensor level, and thermopile readings. Alternative embodiments would learn this on-sight after installation or pre-calculate before installation.

It is envisioned that the current invention can be employed in combination with occupancy detection systems that employ Pyroelectric Infrared (PIR) sensors. A PIR sensor detects motion when voltage generated by its pyroelectric sensor crosses a certain threshold. Currently, this threshold is a factory setting—meaning they are not learned on-site after installation. Due to lack of adaptive threshold, PIRs are error-prone. This is especially true when the difference between foreground and background temperatures fluctuate (e.g., ceiling and floor in the case of a ceiling mounted sensor). For example, long exposure of a zone to high levels of daylight may increase the background temperature and hence result in erroneous PIR output. Embodiments of the invention can calibrate this factory-set threshold (in volts) dynamically by knowing how much daylight is available in the zone. Thus, the current invention can be utilized to provide a dynamic PIR detection threshold (e.g., changing to 1.5V from 1.3V, as discussed below) to improve occupancy detection when daylight is present. In various embodiments of the invention, the proposed system can be stand-alone or embedded in room luminaires.

Additional embodiments of the invention enable a number of applications for connected lighting as follows: 1) Better real-time control of artificial lights through better estimation of daylight; 2) Better blind control based on improved estimate of heat gain entering the indoor space; 3) Improved PIR occupancy sensor's fidelity by dynamically controlling sensor thresholds depending on infrared radiation due to daylight.

The above and other exemplary features, aspects, and advantages of the present invention will be more apparent from the following detailed description taken in conjunction with the accompanying drawings, in which:

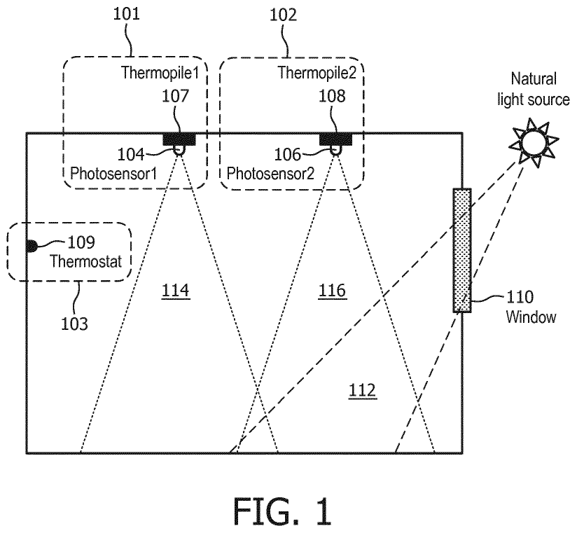

FIG. 1 illustrates an exemplary configuration where the invention's sensing system is deployed in a typical office building.

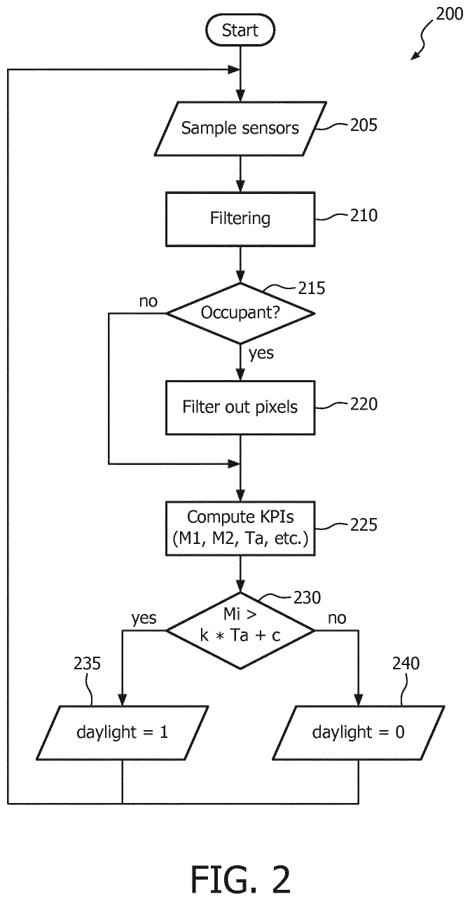

FIG. 2 is a flowchart indicating the method employed by an embodiment of the invention.

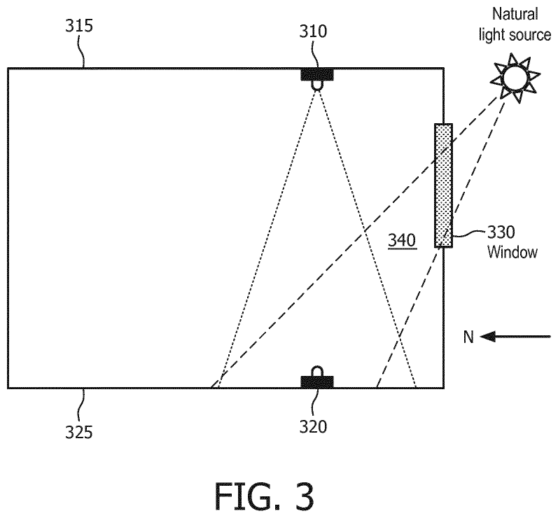

FIG. 3 illustrates the configuration of an experimental room in which concepts of the invention's sensing system was tested.

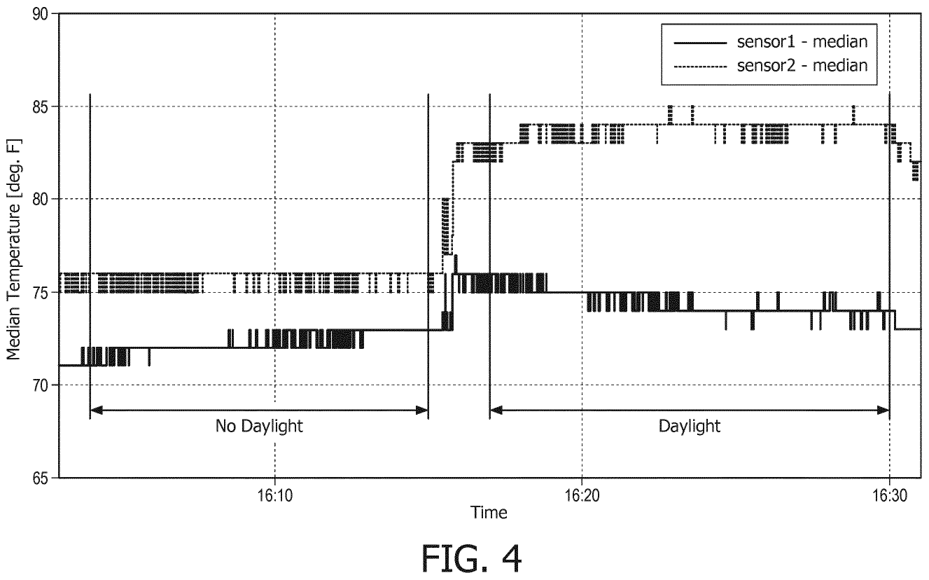

FIG. 4 is a graph depicting the results from a daylighting experiment using a commercial thermopile array.

It is to be understood that these drawings are solely for purposes of illustrating the concepts of the invention and are not intended as a definition of the limits of the invention. It will be appreciated that the same reference numerals, possibly supplemented with reference characters, where appropriate, have been used throughout to identify corresponding parts.

While daylight harvesting lighting control systems attempt to provide optimal use of natural light and artificial light, such systems would attain greater benefits by utilizing the current invention's ability to detect and quantify provided light by using a combination of visual and non-visual sensors. The main elements of one embodiment of the current invention include:
a) A sensing system in which a combination of visual and non-visual (e.g., thermal) sensors are integrated to detect overall light and temperatures of objects in the region being viewed.
b) A signal processing algorithm that can estimate Key Performance Indicators (KPIs) from the raw sensor measurements. Such KPIs to include, but be limited to:
   zone's exposure to daylight (yes/no),
   level of daylight and solar heat gain (high/medium/low),
   estimated daylight intensity (in lux),
   estimated solar heat gain (in Btu)
c) A decision algorithm that converts the KPIs into actions. In various embodiments this decision algorithm comprises us of:
   dynamic Pyroelectric (PIR) detection threshold. The resolution of PIR sensors in detecting human objects varies depending on the background temperature. For example, the resolution might be +/−4 degrees C. for winter and +/−2 degrees C. for summer. However, unlike the typical prior-art PIRs that come with single setpoint that may be configured at the factory, one embodiment of the invention employs dynamic thresholding applied to PIR sensors depending on the information provided by one or more thermopile sensors. By way of example, when a controlled zone is warmer than normal, the detection threshold for PIR sensors shall be increased slightly (e.g., 1.5V instead of 1.3V) to avoid false positives.
   dynamic thermostat cooling setpoint (say 70 degree F. instead of 68 degree F.)

In various embodiments of the invention, a sensory system is employed to measure ambient parameters such as light intensity, air temperature, infrared temperature, occupant presence, etc. An on-board micro controller is directly interfaced with the sensors where each sensor is sampled and processed. The list of sensors include, but are not limited to: photodiode, thermopile, thermistor, humidity sensor, etc. The sensor system can be standalone or embedded in a luminaire. Further, the sensor system may be connected to a central controller or cloud where collective processing may be performed.

FIG. 1 shows an exemplary embodiment where the proposed sensing system is deployed in a typical office building. In this setup, two sensor units 101, 102 are placed in the ceiling while one 103 is placed along a back wall, facing an exterior window 110. When exposed to Sun, the window 110 allows daylight to penetrate into the space and heats up objects (floor, table, air etc.) inside the building. The proposed system can instantaneously and quantitatively detect the presence of daylight (indicated by the area 112 appearing between the two dashed lines) in the sensor view regions (indicated by the areas 114 and 116 each appearing between two dotted lines corresponding to photosensor 1 (104) and photosensor 2 (106), respectively).

As depicted in FIG. 1, each sensor unit comprises a thermopile array, (107 and 108, respectively). A thermopile is a non-contact sensor that measures absolute temperature using infrared radiation emitted by a heat source. A thermopile array is a 2D arrangement of thermopiles. A typical 8×8 thermopile array sensor divides the viewing area into 8×8 cells and provides 64 absolute temperatures per measurement, one for each cell. Thus, a thermopile is fundamentally different from a pyroelectric (PIR) sensor, which only measures a temperature gradient. PIRs are insensitive to stationary occupants while thermopiles can detect non-moving individuals, as the measured absolute temperature (human body temperature) in the viewing region will be higher than that of environment.

FIG. 2 is a flowchart depicting the method for detecting the presence of daylight in real-time, according to one embodiment of the invention. As illustrated, the sensors are periodically sampled (step 205) and then filtered (step 210) to remove unwanted noise in the signal. The filtered signals are then analyzed to identify if there are any occupants in the space (step 215). For example, when a zone observes both occupant and daylight, the signal source due to any occupants will dominate that of daylight. Such signals can be separated using sophisticated filters. To avoid this bias, the embodiment filters out detected occupants from the measurements. In simple cases, this means just removing the thermopile pixels (or elements) from the measurement that are impacted by occupants (step 220). There are also other standard techniques where differential operations can remove bias due to occupants without incurring significant pixel loss. At step 225 a number of parameters are then determined such as air temperature (Ta), median object temperature (M1, M2) from each thermopile array, etc. This information is then used to detect whether daylight is present or not in a thermopile sensor view region. In the embodiment of the invention depicted in FIG. 2, the following decision criteria is employed (steps 230 and 240):

daylight=1 if Mi>k*Ta+c and,

0 if Mi<k*Ta+c

where: Mi is the median pixel temperature of thermopile i
Ta is the average air temperature computed from sensors placed in different locations, and
k, c are coefficients that are either hard-coded or learned during training

Thus in embodiments of the invention, daylight is determined to be present in each area being monitored by a thermopile array. The level of daylight is then estimated using solar heat gain. In the prior art, solar heat gains are typically computed using solar irradiance, a window heat transfer function and a space transfer function. However, in practical applications it is difficult to acquire real-time solar irradiance at every window or lighting control zone. Embodiments of the invention extract this information from the thermopile measurements where calibration is performed prior to installation, and the transfer coefficients are learned on-site. For usage in various control techniques, embodiments of the invention will thereby characterize daylight (if present) into one of high, medium, and low categories.

As noted above, embodiments of the invention employ a regression model learned either on-site or off-site. The amount of daylight entering the space is then estimated using data obtained from thermopile arrays and photo-sensors.

By way of example, several experiments were conducted with commercial low-cost thermopile arrays in accordance with the concepts of the invention. In particular and as illustrated in FIG. 3, an experimental setup was established where two (16×14) commercial thermopile arrays (310,320) were placed in an indoor space which has a south facing window 330. The sensors were placed facing each other along the east 315 and west 325 walls of the room. A data measurement was carried out for about 30 minutes where during the first 15 minutes (16:00 to 16:15) the window was blocked completely preventing daylight entry into the space. During the next 15 minutes (16:15 to 16:30), the window blocks were removed exposing the room to solar radiation. In this setup, sensor 2 (320) had direct exposure to solar radiation 340 while sensor 1 (310) was exposed to the wall (325) that received direct irradiance.

FIG. 4 show the results from the above experiment as a function of time. In particular, the graph shows the median temperatures of each (64 pixel) thermopile array measured every second during the experiment. It can be observed that both sensors show detectable increase/decrease in median temperature in presence/absence of daylight respectively. The intensity of temperature increase depends on the sensor's exposure (orientation, in this case). For example, the median temperature of sensor 2 (item 320), directly exposed to solar irradiation, is increased by about 9 degrees F.; while that of sensor 1 (item 310) rose about 4 degrees F. Thus, the experimental results illustrated in FIG. 4 provide two examples of the invention's ability to detect sunlight using one or more thermopile arrays.

Embodiments of the invention have various applications in HVAC systems. In most of buildings, thermostats are set to standard cooling/heating setpoints and are often unchanged. In reality, a number of factors determine optimal setpoints in order to achieve improved comfort and increased energy savings in buildings. For example, solar heat gain due to incoming daylight increases air temperature of a thermal zone. In winter, this can be used to reduce cooling load by lowering the heating setpoint by a few degrees. Alternatively, in summer, this heat gain adversely impacts cooling systems which can be again mitigated by adjusted setpoints for increased comfort or by adjusting blinds for increased energy savings for cooling. Embodiments of the invention will help making such choices of dynamically adjusting thermostat setpoints in real-time as an estimate of daylight entering the space can be determined (and from which determination, solar heat gain can be estimated more accurately).

While there has been shown, described, and pointed out fundamental novel features of the present invention as applied to preferred embodiments thereof, it will be understood that various omissions and substitutions and changes in the apparatus described, in the form and details of the devices disclosed, and in their operation, may be made by those skilled in the art without departing from the spirit of the present invention. It is expressly intended that all combinations of those elements that perform substantially the same function in substantially the same way to achieve the same results are within the scope of the invention. Substitutions of elements from one described embodiment to another are also fully intended and contemplated. For example, any numerical values presented herein are considered only exemplary and are presented to provide examples of the subject matter claimed as the invention. Hence, the invention, as recited in the appended claims, is not limited by the numerical examples provided herein.

1. A system for analyzing the overall illuminance of an environment to thereby detect and quantify a daylight component of the illuminance, wherein the system comprises:
a thermopile array;
a photo-sensor; and,
a computer processor which filters the inputs from the thermopile array and the photo-sensor and determines a level of daylight that is present in the overall illuminance.

2. The system of claim 1 further comprising at least one Pyroelectric Infrared (PIR) sensor, wherein said PIR sensor is capable of determining the presence of one or more human occupants, wherein, if the presence of a human occupant is determined, the computer processor filters a human occupant thermopile component from the inputs from the thermopile array and the photo-sensor.

3. (canceled)

4. The system of claim 1, wherein the computer processor is located remotely from the thermopile array.

5. (canceled)

6. (canceled)

7. An occupancy detection system that utilizes the system of claim 1 to determine one or more dynamic PIR detection thresholds.

8. The system of claim 1, wherein the environment is an indoor region and the filtering performed by the computer processor comprises filtering out sensor measurements effected by one or more occupants of the indoor region.

9. The system of claim 1, wherein the determining the extent to which daylight is present comprises applying the following decision rule:
level of daylight=high if Mi>k*Ta+c and,
medium if Mi=k*Ta+c and,
low if Mi<k*Ta+c
where: Mi is the median pixel temperature of thermopile i,
Ta is the average air temperature computed from sensors placed in different locations, and
k, c are coefficients that are either hard-coded or learned during training.

10. The system of claim 9 wherein said training comprises:
obtaining multiple sensor inputs form one or more thermopile arrays and from one or more photo-sensor arrays, said sensor inputs being obtained at multiple times of the day having different amounts of daylight entering the environment; and,
developing a regression model to determine the k and c coefficients.

11. A method for determining a distribution of daylight and artificial light in an indoor region, the method comprising the steps of:
monitoring at least part of the indoor region by at least one thermopile array;
monitoring at least part of the indoor region by at least one photo-sensor;
analyzing at least one of the outputs of the thermopile array and the photo-sensor array to estimate the intensity of the region's exposure to daylight.

12. The method of claim 11, further comprising monitoring at least part of the indoor region by a Pyroelectric Infrared (PIR) sensor to detect the presence of one or more human occupants, wherein, if the presence of a human occupant is determined, the filtering a human occupant thermopile component from the inputs from the thermopile array and the photo-sensor.

13. The method of claim 11, wherein the analyzing step comprises filtering out sensor measurements effected by at least one of said one or more human occupants.

14. The method of claim 11, wherein the analyzing step further comprises applying the following decision rule to detect whether daylight is present:
level of daylight=high if Mi>k*Ta+c and,
medium if Mi=k*Ta+c and,
low if Mi<k*Ta+c
where: Mi is the median pixel temperature of thermopile i,
Ta is the average air temperature computed from sensors placed in different locations, and
k, c are coefficients that are either hard-coded or learned during training.

15. The method of claim 14 wherein said training comprises:
obtaining multiple sensor inputs form one or more thermopile arrays and from one or more photo-sensor arrays, said sensor inputs being obtained at multiple times of the day having different amounts of daylight entering the indoor region; and,
developing a regression model to determine the k and c coefficients.

16. The method of claim 11, further comprising the step of controlling the distribution of daylight and artificial light in an indoor region.

17. The method of claim 16 further comprising:
adjusting the amount of daylight entering the indoor region; and,
controlling the amount of artificial light in the indoor region.

18. A method of providing a dynamic PIR detection threshold for an occupancy detection system, said method using the method of claim 11.
